(19) United States
(12) Patent Application Publication
(10) Pub. No.: US 2022/0385833 A1
(43) Pub. Date: Dec. 1, 2022

(54) INFORMATION PROCESSING APPARATUS, IMAGE CAPTURING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: Shinya Taoki, Kanagawa (JP)

(21) Appl. No.: 17/736,268

(22) Filed: May 4, 2022

(30) Foreign Application Priority Data
May 28, 2021 (JP) 2021-090589

(51) Int. Cl. H04N 5/265; G06T 7/70; H04N 5/232; H04N 5/262; H04N 5/247

(52) U.S. Cl. CPC H04N 5/265; G06T 7/70; H04N 5/23299; H04N 5/23238; H04N 5/2628; H04N 5/247; G06T 2207/30244; H04N 7/18

(57) ABSTRACT

An obtaining unit is configured to obtain image capturing direction information indicating an image capturing direction of a first image capturing part that can change the image capturing direction. A determining unit is configured to determine, in accordance with the image capturing direction of the first image capturing part, a second image capturing part having an image capturing direction closest to the image capturing direction of the first image capturing part in an image capturing part set including a plurality of image capturing parts having a different image capturing direction. A generating unit is configured to generate a combined image such that an image captured by the second image capturing part is arranged at a predetermined position in the combined image by combining images captured by the respective image capturing parts in the image capturing part set.

### BACKGROUND OF THE INVENTION

### Field of the Invention

The present invention relates to an information processing apparatus, an image capturing apparatus, an information processing method, and a non-transitory computer readable storage medium.

### Description of the Related Art

Network camera systems have been used for monitoring intruders or the like into restricted areas or the like in, for example, public buildings or places, banks, stores, such as supermarkets, dams, bases, or airfields. A multi-eye camera with an omnidirectional camera and a PTZ camera combined, for example, has been known as a camera used in the network camera systems. The omnidirectional camera refers to a camera that can capture a 360° omnidirectional image with a plurality of image sensors installed at a predetermined position of a casing of the camera. The omnidirectional camera refers to a camera in which an omnidirectional image is obtained by combining images in a predetermined image capturing range captured by each of the image sensors.

The PTZ camera has a pan, tilt, and zoom mechanisms, enabling its image capturing range to be changed. A multi-eye camera with the omnidirectional camera and the PTZ camera combined can output a video captured by the omnidirectional camera and a video in a specific range captured by the PTZ camera. For example, Patent Document 1 discloses a technique for facilitating correspondence between the position of each camera of the multi-eye camera and the position of a displayed image in accordance with the orientation (angle) of the multi-eye camera at the time of image capturing when the captured image is rotated (see Japanese Patent Laid-Open No. 2013-179397).

### SUMMARY OF THE INVENTION

The present invention in its one aspect provides an information processing apparatus comprising an obtaining unit configured to obtain an image capturing direction information indicating an image capturing direction of a first image capturing part that can change the image capturing direction, a determining unit configured to determine, in accordance with the image capturing direction of the first image capturing part, a second image capturing part having an image capturing direction closest to the image capturing direction of the first image capturing part in an image capturing part set including a plurality of image capturing parts having a different image capturing direction, a generating unit configured to generate a combined image such that an image captured by the second image capturing part determined by the determining unit is arranged at a predetermined position in the combined image by combining images captured by the respective image capturing parts in the image capturing part set, and an outputting unit configured to output the combined image generated by the generating unit.

The present invention in its one aspect provides an information processing apparatus comprising an obtaining unit configured to obtain an image capturing position information indicating an image capturing position of a first image capturing part that can change the image capturing position, a determining unit configured to determine, in accordance with the image capturing position information of the first image capturing part, coordinates corresponding to the image capturing position of the first image capturing part on an omnidirectional image captured by an omnidirectional image capturing part that can perform omnidirectional image capturing, a generating unit configured to correct the omnidirectional image to generate an omnidirectional image such that the coordinates is positioned at specified coordinates prespecified on the omnidirectional image, and an outputting unit configured to output the omnidirectional image generated by the generating unit.

The present invention in its one aspect provides an information processing apparatus comprising an obtaining unit configured to obtain an image capturing position information indicating an image capturing position of a first image capturing part that can change the image capturing position, a generating unit configured to generate an omnidirectional image in accordance with an image capturing result from an omnidirectional image capturing part that can perform omnidirectional image capturing such that coordinates corresponding to the image capturing position of the first image capturing part on the omnidirectional image are positioned at specified coordinates prespecified on the omnidirectional image, and an outputting unit configured to output the omnidirectional image generated by the generating unit.

The present invention in its one aspect provides an information processing method comprising obtaining an image capturing direction information indicating an image capturing direction of a first image capturing part that can change the image capturing direction, determining, in accordance with the image capturing direction of the first image capturing part, a second image capturing part having an image capturing direction closest to the image capturing direction of the first image capturing part in an image capturing part set including a plurality of image capturing parts having a different image capturing direction, generating a combined image such that an image captured by the second image capturing part determined by the determining is arranged at a predetermined position in the combined image by combining images captured by the respective image capturing parts in the image capturing part set, and outputting the combined image generated by the generating.

The present invention in its one aspect provides a non-transitory computer readable storage medium storing a program that, when executed by a computer, causes the computer to perform an information processing method comprising obtaining an image capturing direction information indicating an image capturing direction of a first image capturing part that can change the image capturing direction, determining, in accordance with the image capturing direction of the first image capturing part, a second image capturing part having an image capturing direction closest to the image capturing direction of the first image capturing part in an image capturing part set including a plurality of image capturing parts having a different image capturing direction, generating a combined image such that an image captured by the second image capturing part determined by the determining is arranged at a predetermined position in the combined image by combining images captured by the respective image capturing parts in the image capturing part set, and outputting the combined image generated by the generating.

Further features of the present invention will become apparent from the following description of exemplary embodiments (with reference to the attached drawings).

### BRIEF DESCRIPTION OF THE DRAWINGS

FIG. 1 is a block diagram illustrating a configuration of an information processing system according to a first embodiment.

FIG. 2 is a diagram illustrating a configuration of the information processing system according to the first embodiment.

FIG. 3 is a block diagram illustrating a functional configuration of an image capturing apparatus according to the first embodiment.

FIG. 4 is a diagram illustrating an example of a display screen according to the first embodiment.

FIG. 5A is a bottom view of a fixed camera part according to the first embodiment.

FIG. 5B is a table for determining a fixed camera part according to the first embodiment.

FIG. 6 is a flowchart illustrating panoramic image output processing according to the first embodiment.

FIG. 7 is a block diagram illustrating a configuration of an information processing system according to a second embodiment.

FIG. 8A is a diagram illustrating an example of a display screen according to the second embodiment.

FIG. 8B is a diagram illustrating an example of a display screen according to the second embodiment.

FIG. 9 is a flowchart illustrating fish-eye image output processing according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

An embodiment of the present invention can provide a technique enabling easy recognition of a position of a captured image in an omnidirectional image.

### First Embodiment

In a first embodiment, a network camera including an image capturing unit is described as an example. The present embodiment is also applicable to image capturing purposes using an image capturing unit other than the network camera. For example, the present embodiment is also applicable to an image capturing unit for capturing videos or a movies for broadcasting or videos for personal purposes.

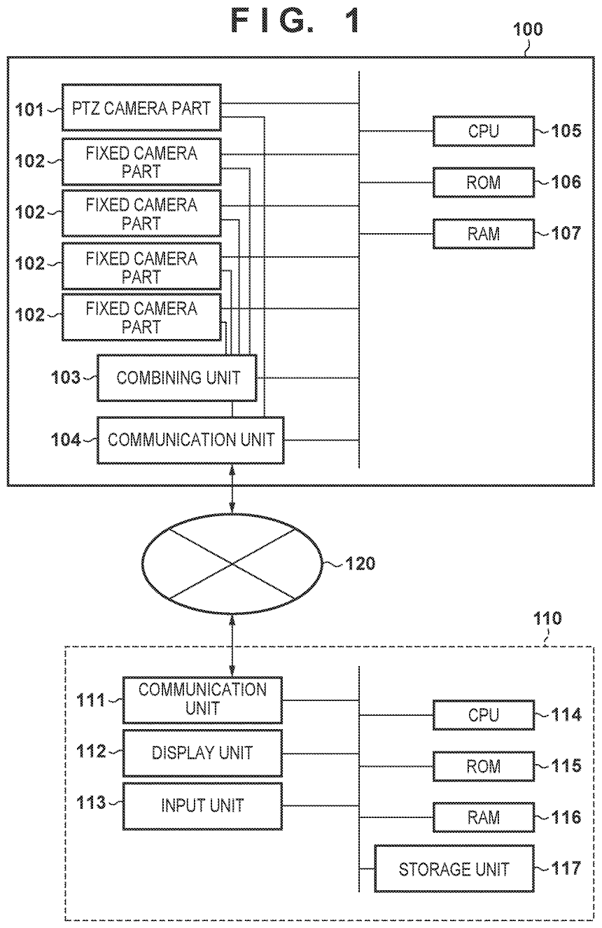

FIG. 1 is a block diagram illustrating a configuration of an information processing system according to the first embodiment. In FIG. 1, an information processing system 10 includes an image capturing apparatus 100, an information processing apparatus 110, and a network 120. The image capturing apparatus 100 is connected to the information processing apparatus 110 through the network 120. The image capturing apparatus 100 is an apparatus that captures an image of a monitored region, processes the obtained captured image, and transmits the processed captured image to the information processing apparatus 110. The information processing apparatus 110 is an apparatus that receives the captured image from the image capturing apparatus 100, processes, and displays the captured image. The captured image in the present embodiment is a video but may also be a still image. In addition, the image capturing apparatus 100 according to the present embodiment includes an information processing apparatus (not illustrated) for executing image processing on the obtained image.

The image capturing apparatus 100 includes a PTZ camera part 101, fixed camera parts 102, a combining unit 103, a communication unit 104, a CPU 105, a ROM 106, and a RAM 107. Note that the number of fixed camera parts 102 provided in the image capturing apparatus 100 is not limited to four as illustrated in FIG. 1 but may be, for example, two or more. The PTZ camera part 101 is an image capturing apparatus that includes a zoom lens and an image sensor and can control pan, tilt, and zoom (hereinafter referred to as PTZ). Thus, the PTZ camera part 101 can change an image capturing range. The PTZ camera part 101 controls the zoom lens and a drive motor in accordance with a control instruction related to the image capturing range received from the information processing apparatus 110. Here, the PTZ camera part 101 is defined as an image capturing part that can change the image capturing range.

On the other hand, the fixed camera parts 102 are image capturing apparatuses each including a fixed lens and an image sensor. To obtain an omnidirectional image with a plurality of images captured by the respective fixed camera parts 102 combined, the fixed camera parts 102 are each installed at a predetermined position of the image capturing apparatus 100. In the present embodiment, the omnidirectional image is a panoramic image. Each of the fixed camera parts 102 captures an image of the corresponding image capturing range from the predetermined position. In the present embodiment, each of the fixed camera parts 102 is not limited to being fixed to the predetermined position, but its predetermined position can be changed to change the image capturing range. For example, each of the fixed camera parts 102 may control the PTZ, as with the case of the PTZ camera part 101. The image sensors of the PTZ camera part 101 and the fixed camera parts 102 are elements that convert an image into an electrical signal in response to light and are, for example, CCD sensors and CMOS sensors.

The combining unit 103 combines a plurality of captured images captured by the respective fixed camera parts 102 into a single panoramic image. The combining unit 103 combines the plurality of captured images captured by the respective fixed camera parts 102 by arranging each of the plurality of captured images in a predetermined region in the panoramic image. The image capturing ranges of the respective fixed camera parts 102 include different image capturing ranges that do not overlap each other, but the present embodiment also includes a case where part of the image capturing ranges overlap part of other image capturing ranges.

The communication unit 104 transmits and receives captured images and information to and from the information processing apparatus 110 over the network 120. For example, the communication unit 104 compresses the captured image and outputs the captured image to the information processing apparatus 110 over the network 120. The CPU 105 implements various types of processing by reading a control program stored in the ROM 106 and executing the control program. The RAM 107 is used as a temporary storage area, such as a main memory for the CPU 105 or a work area. Functions and processing of the image capturing apparatus 100 described below are implemented with the CPU 105 reading a program stored in the ROM 106 and executing the program. The CPU 105 may read a program stored in a recording medium, such as a USB or an SD card, instead of the ROM 106 or the like.

The information processing apparatus 110 is an apparatus for processing various types of data and is an information processing apparatus such as a PC, a smartphone, a tablet, or the like. The information processing apparatus 110 includes a communication unit 111, a display unit 112, an input unit 113, a CPU 114, a ROM 115, a RAM 116, and a storage unit 117. The communication unit 111 transmits and receives information to and from the image capturing apparatus 100 over the network 120. The display unit 112 is a device that displays various types of information processed by the CPU 114, and is, for example, a liquid crystal display (LCD) or an organic EL display (OLED). The display unit 112 can display the captured image captured by the PTZ camera part 101 and an omnidirectional image with the images captured by the respective fixed camera parts 102 unified. The input unit 113 includes a receiving unit for receiving various operations by the user, and is, for example, a keyboard, a mouse, and a joystick. The user can input an operation to the input unit 113 to perform PTZ control on the PTZ camera part 101 for example. The CPU 114 reads a control program stored in the ROM 115 and executes the control program to implement various types of processing.

The RAM 116 is used as a temporary storage area such as a main memory or a work area, by the CPU 114. The storage unit 117 is a storage device that stores various types of data and program and is, for example, an HDD or an SSD. Functions and processing of the information processing apparatus 110 described below are implemented with the CPU 114 reading a program stored in the ROM 115 or the storage unit 117 and executing the program. The CPU 114 may read a program stored in a recording medium, such as a USB or an SD card, instead of the ROM 115 or the like.

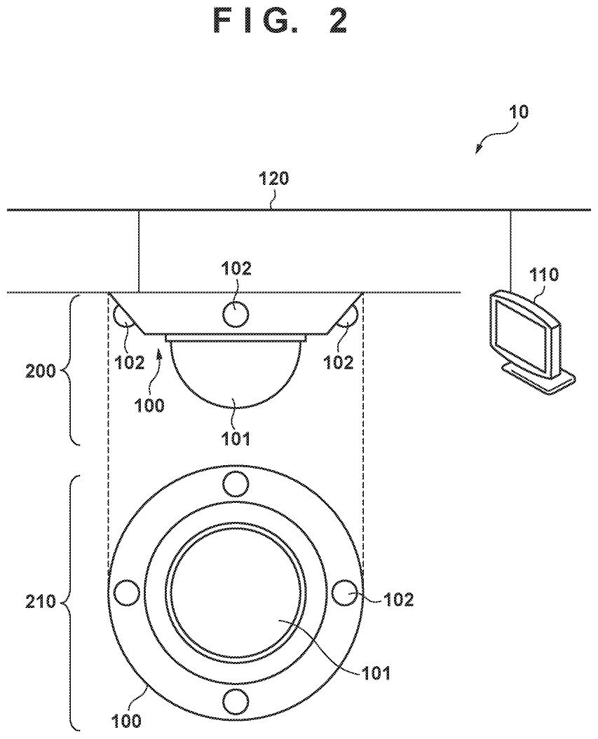

FIG. 2 is a diagram illustrating a configuration of the information processing system according to the first embodiment. In FIG. 2, a side view 200 illustrates the image capturing apparatus 100 as viewed from a side surface, and a bottom view 210 illustrates the image capturing apparatus 100 as viewed from a bottom surface. In the side view 200 of FIG. 2, the image capturing apparatus 100 is installed on a ceiling of a structure, for example. In the bottom view 210 of FIG. 2, the PTZ camera part 101 is installed at the center of the fixed camera parts 102 to be surrounded by the same. In the present embodiment, each of the fixed camera parts 102 is also referred to as an image capturing part set including a plurality of image capturing parts. The fixed camera parts 102 are arranged at a constant interval in a circumferential direction of the PTZ camera part 101, for capturing an omnidirectional image using the fixed camera parts 102. The constant interval is 90° in the present embodiment as illustrated in FIG. 2 but is not limited to this, and an appropriate interval may be set in accordance with the number of fixed camera parts 102.

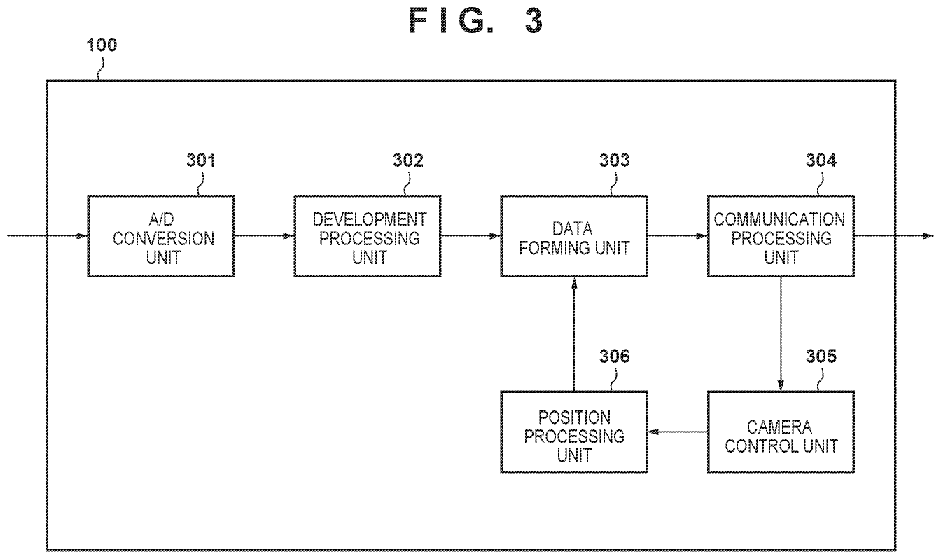

FIG. 3 is a block diagram illustrating a functional configuration of the image capturing apparatus according to the first embodiment. In FIG. 3, the image capturing apparatus 100 includes an A/D conversion unit 301, a development processing unit 302, a data forming unit 303, a communication processing unit 304, a camera control unit 305, and a position processing unit 306. The A/D conversion unit 301 performs analog-to-digital conversion on a signal corresponding to light received by the image sensors of the PTZ camera part 101 and the fixed camera parts 102, to obtain a captured image. The development processing unit 302 converts the captured image obtained by the A/D conversion unit 301 by using a predetermined method. The data forming unit 303 generates the captured image after the development processing and a panoramic image using a plurality of captured images and transmits these images to the communication processing unit 304. The communication processing unit 304 transmits, over the network 120, the images to the information processing apparatus 110.

The camera control unit 305 receives a camera control instruction input through a user operation via the communication processing unit 304. The camera control unit 305 controls the image capturing by the PTZ camera part 101 and the fixed camera parts 102 based on the control instruction. The camera control unit 305 also performs PTZ control on the PTZ camera part 101. The position processing unit 306 obtains image capturing direction information of the PTZ camera part 101 and the fixed camera parts 102. The image capturing direction information is assumed to be an angle in a pan direction (pan angle) and an angle in a tilt direction (tilt angle) of the PTZ camera part 101 and the fixed camera parts 102. The position processing unit 306 also obtains image capturing direction information of each of the PTZ camera part 101 and the fixed camera parts 102 after the PTZ control is performed. The data forming unit 303 combines a panoramic image and an image captured by the fixed camera part 102 whose image capturing direction is closest to the image capturing direction of the PTZ camera part 101 obtained from the position processing unit 306 arranged in a center of a panoramic image into a panoramic image. Note that the position where the image captured by the fixed camera part 102 described above is arranged on the panoramic image is not limited to the center, and may be a position selected by the user.

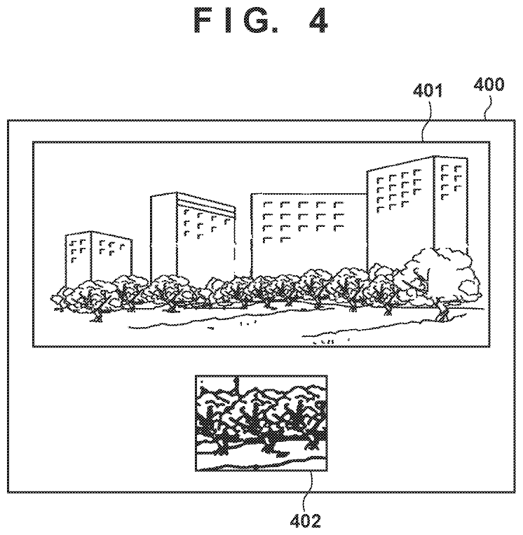

FIG. 4 is a diagram illustrating an example of a display screen according to the first embodiment. In FIG. 4, a display screen 400 is a screen displayed by the display unit 112 and displays a panoramic image 401 and a captured image 402. The panoramic image 401 is a panoramic image with a plurality of captured images captured by the respective fixed camera parts 102 combined (combined image). The captured image 402 is a captured image captured by the PTZ camera part 101. The captured image 402 is displayed directly below the center of the panoramic image 401, but this is not limited. The display positions of the panoramic image 401 and the captured image 402 on the display screen 400 may be swapped.

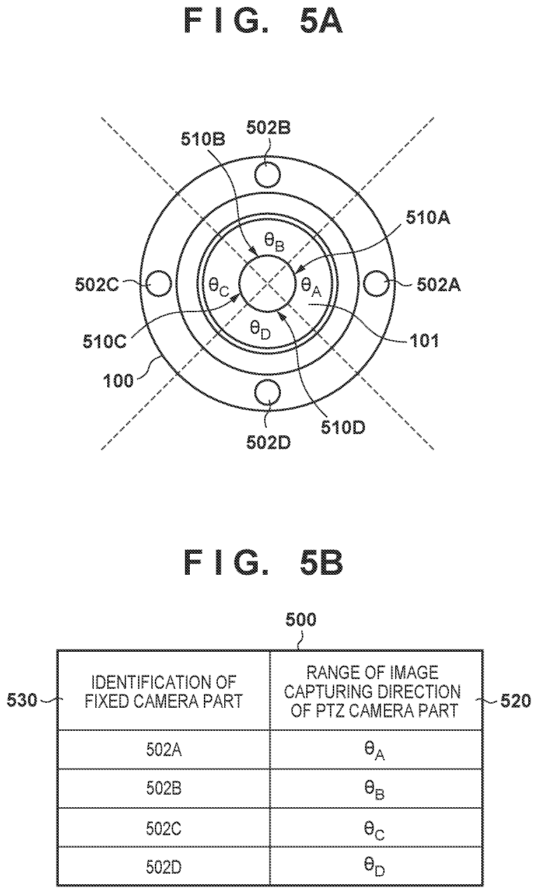

FIG. 5A is a bottom view of a fixed camera part according to the first embodiment. In FIG. 5A, a fixed camera part 502A, a fixed camera part 502B, a fixed camera part 502C, and a fixed camera part 502D represent the fixed camera parts 102. Image capturing ranges 510A to 510D represent the image capturing range of the PTZ camera part 101. The image capturing ranges 510A to 510D are respectively indicated by θ_{A} to θ_{D} in FIG. 5A. Two crossing broken lines indicate are boundaries provided for describing each of the image capturing ranges 510A to 510D. Each of θ_{A} to θ_{D} in the present embodiment corresponds to 90° as a result of segmenting the movable range 360° of the PTZ camera part 101 in the pan direction in four, but this is not limited.

FIG. 5B illustrates a table for determining a fixed camera part whose image capturing direction is closest to the image capturing direction of the PTZ camera part 101. In the present embodiment, the table is also referred to as correspondence information. This table 500 includes an identification 530 and an image capturing range 520. The identification 530 indicates each of the fixed camera parts 502A to 502D. The image capturing range 520 indicates OA to GD that are image capturing ranges of the PTZ camera part 101 respectively corresponding to the fixed camera parts 502A to 502D. In the present embodiment, the table is stored in advance in at least any of the ROM 106 of the image capturing apparatus 100, or the ROM 115 or the storage unit 117 of the information processing apparatus. The position processing unit 306 obtains the image capturing direction (pan angle) of the PTZ camera part 101 and determines which one in the image capturing range 520 in the table 500 corresponds to the image capturing direction obtained. When determining that the image capturing direction (pan angle) obtained corresponds to GA in, for example, the image capturing range 520, the position processing unit 306 determines that the fixed camera part whose image capturing direction is closest to the image capturing direction of the PTZ camera part 101 is the fixed camera part 502A. The position processing unit 306 can determine the fixed camera part whose image capturing direction is closest to the image capturing direction of the PTZ camera part 101 by referring to the table 500. Through calculation based on the image capturing direction information of the PTZ camera part 101, the position processing unit 306 may determine the fixed camera part with the closest image capturing direction, without referring to the table 500. The image capturing direction is specified by the pan direction of the PTZ camera part 101 in the present embodiment, but this is not limited. For example, when PTZ control of the fixed camera parts 502A to 502D can be performed, the range of the image capturing direction can be specified with the tilt direction, the pan direction, and a zoom ratio considered.

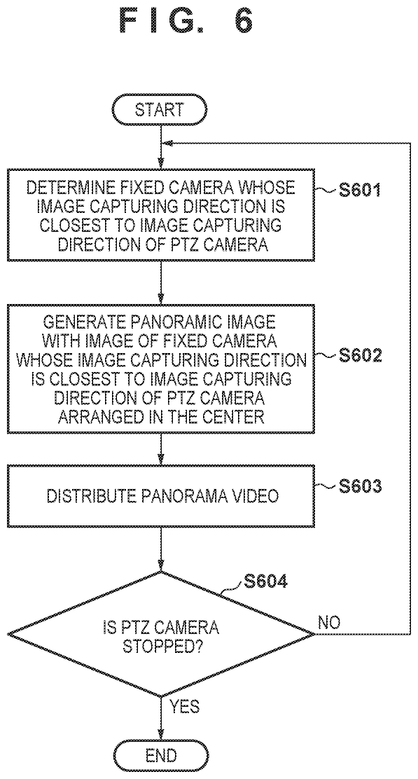

FIG. 6 is a flowchart illustrating panoramic image output processing according to the first embodiment. The present embodiment describes panoramic image output processing by using an example where the PTZ camera part 101 captures images while changing the image capturing direction in the pan direction, and the fixed camera parts 102 each capture an image at a fixed image capturing position. The panoramic image output processing according to the present embodiment will be described below with reference to FIGS. 4, 5A, and 5B.

In S601 in FIG. 6, the position processing unit 306 obtains the image capturing direction of the PTZ camera part 101 controlled by the camera control unit 305. The position processing unit 306 refers to the association between the physical position of each of the fixed camera parts 102 and the image capturing range 520 in the image capturing direction of the PTZ camera part 101 based on the table 500 in FIG. 5B stored in advance in the ROM 106. Thus, the position processing unit 306 determines the fixed camera part 102 whose image capturing direction is closest to the image capturing direction of the PTZ camera part 101. The position processing unit 306 refers to the table 500 to determine the fixed camera part 102 whose image capturing direction is closest to the image capturing direction of the PTZ camera part 101, but this is not limited.

In S602, the data forming unit 303 generates a panoramic image such that the image captured by the fixed camera part 102 whose image capturing direction is closest to the image capturing direction of the PTZ camera part 101 is arranged in the center of the panoramic image. With the captured image captured by the PTZ camera part 101 displayed in the center of the panoramic image, the user can easily identify this captured image in the panoramic image. In S603, the communication processing unit 304 outputs the panoramic image generated by the data forming unit 303 to the display unit 112. In the present embodiment, the panoramic image is also referred to as an output result. The display unit 112 displays the panoramic image and the captured image on the display screen 400 in FIG. 4. Note that the display unit 112 may display at least one of the panoramic image and the captured image. In S604, the position processing unit 306 determines whether the PTZ camera part 101 is changing the image capturing direction. When the position processing unit 306 determines that the PTZ camera part 101 is not changing the image capturing direction (Yes in S604), the processing ends. When the position processing unit 306 determines that the PTZ camera part 101 is changing the image capturing direction (No in S604), the processing returns to S601, and the position processing unit 306 obtains the image capturing direction of the PTZ camera part 101 after in the image capturing direction is changed.

The present embodiment generates the panoramic image with the captured image captured by the fixed camera part 102 whose image capturing direction is closest to the image capturing direction of the PTZ camera part 101 positioned in the center of the panoramic image, but this is not limited. The captured image captured by the fixed camera part 102 described above may be displayed at a position in the panoramic image designated by the user in advance. With the present embodiment, the image capturing direction of the PTZ camera part 101 can be easily identified from the panoramic image, whereby a load on the user for monitoring an intruder or the like can be reduced.

As described above, the first embodiment enables the panoramic image to be generated such that the image captured by the fixed camera whose image capturing direction is closest to the image capturing direction of the PTZ camera that can control the image capturing direction is arranged at a predetermined position on the panoramic image. This enables the first embodiment to easily recognize where the captured image captured by the PTZ camera is displayed on the panoramic image.

### Second Embodiment

The first embodiment generates a panoramic image with the image capturing direction of the PTZ camera positioned in the center of the panoramic image by using a multi-eye camera including the PTZ camera and the plurality of fixed cameras. On the other hand, a second embodiment uses a multi-eye camera including a PTZ camera and a fish-eye camera and thus does not require the processing of combining a plurality of images into a panoramic image. Further, the second embodiment generates a fish-eye image with coordinates corresponding to the image capturing direction of the PTZ camera positioned at coordinates in at upper center of the fish-eye image. The second embodiment describes fish-eye image output processing by using the multi-eye camera including the PTZ camera and the fish-eye camera. In the second embodiment, a difference from the first embodiment will be described.

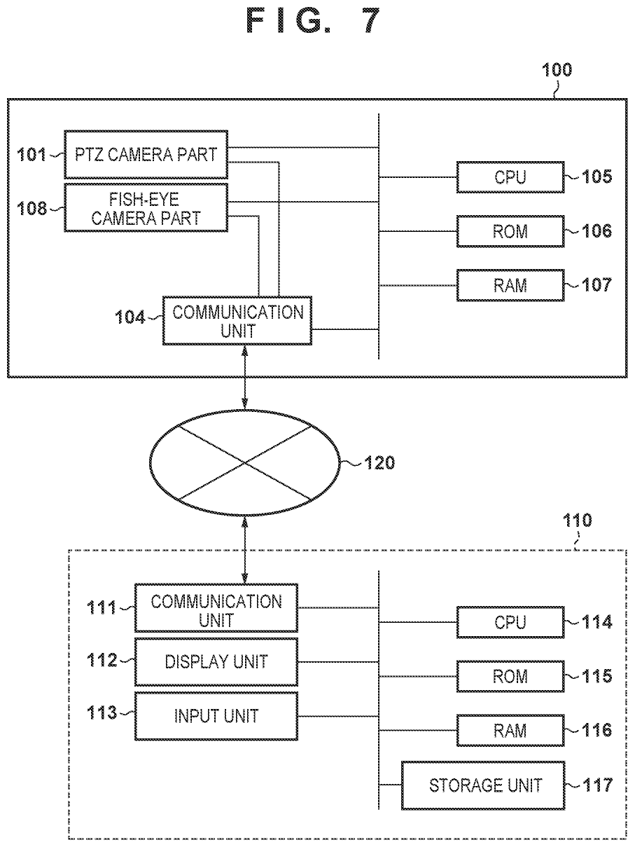

FIG. 7 is a block diagram illustrating a configuration of an information processing system according to the second embodiment. In FIG. 7, the information processing system 10 includes the image capturing apparatus 100, the information processing apparatus 110, and the network 120. An image capturing apparatus 100 includes a PTZ camera part 101, a fish-eye camera part 108, and a communication unit 104. The combining unit 103 can combine at least one of, for example, a panoramic image or a segment image obtained by dewarping a fish-eye image. Alternatively, the combining unit 103 can combine a fish-eye image by rotating a fish-eye image in a clockwise or counterclockwise direction, to position the coordinates corresponding to the image capturing direction of the PTZ camera part 101 at specified coordinates on the fish-eye image. The predetermined position is an upper center on the fish-eye image in the present embodiment, but this is not limited, and any coordinates on the fish-eye image may be set by a user selection, for example. The fish-eye camera part 108 is an image capturing part that includes an image sensor such as a CMOS sensor and a fish-eye lens, and can capture images in a 360° image capturing range. In the present embodiment, the data forming unit 303 in FIG. 3 executes the following processing based on the image capturing direction of the PTZ camera part 101 obtained from the position processing unit 306 and a result of image capturing by the fish-eye camera part 108. The data forming unit 303 generates a fish-eye image with the image capturing direction of the PTZ camera part 101 positioned in the upper center on the fish-eye image.

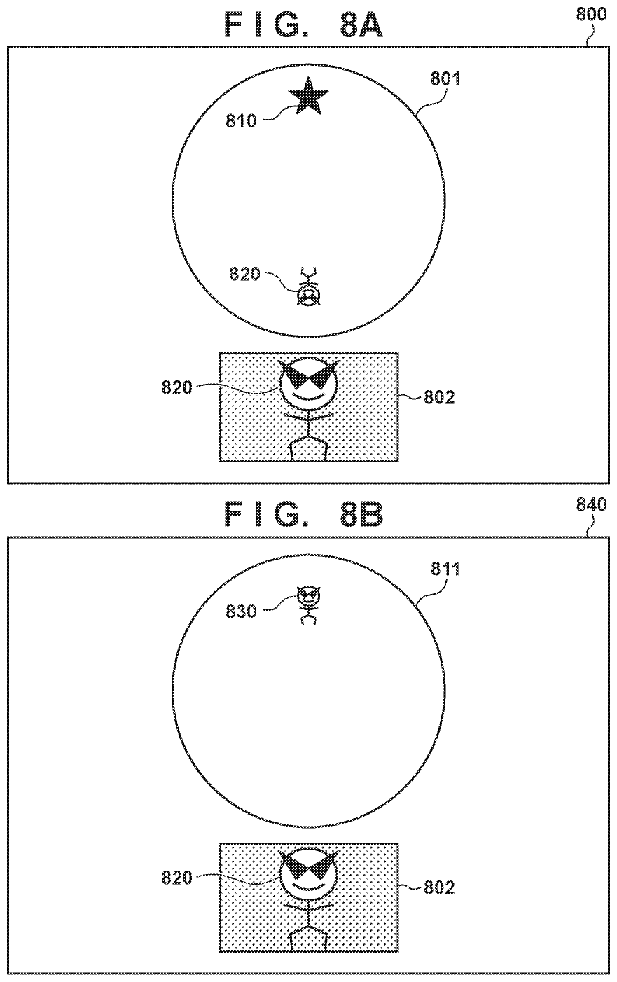

FIGS. 8A and 8B are diagrams each illustrating an example of a display screen according to the second embodiment. In FIG. 8A, a display screen 800 includes a fish-eye image 801 and a captured image 802. The fish-eye image 801 is a fish-eye image that is an omnidirectional image captured by the fish-eye camera part 108 and is displayed as a circular image. The fish-eye image 801 displays specified coordinates 810 and a target 820. The target 820 is displayed in a lower center in the fish-eye image 801, while being in an upside down standing state. On the other hand, the captured image 802 is a rectangular image captured by the PTZ camera part 101 and displays the target 820 in a standing straight state. As described above, the fish-eye image 801 is different from the captured image 802 in the displayed state and position of the target 820. The user needs to search the captured image 802 for the target 820 in the fish-eye image 801, and thus cannot quickly identify the target 820. The present embodiment performs image processing described below on the fish-eye image 801 to easily identify the target 820.

The specified coordinates 810 are coordinates specified to arrange the image capturing direction of the PTZ camera part 101 at a predetermined position on the fish-eye image 801. Note that the specified coordinates 810 may be set on an omnidirectional image other than the fish-eye image. The predetermined position in the present embodiment is the upper center of the fish-eye image 801 to enable the user to easily identify the captured image 802. The predetermined position is not limited to the upper center of the fish-eye image 801, and any position on the fish-eye image 801 may be set in advance by the user selection. As illustrated in FIG. 8A, the specified coordinates 810 are displayed with, for example, a star mark and is expressed by a two-dimensional coordinate system (X, Y). A screen 840 in FIG. 8B displays a fish-eye image 811 as a result of correcting the display screen 800 in FIG. 8A. The data forming unit 303 executes image processing of rotating the fish-eye image 801 clockwise or counterclockwise to position the target 820, on the fish-eye image 801, at the specified coordinates 810. This enables the display unit 112 to display a target 830 at the upper center of the fish-eye image 811, enabling the user to easily identify the target 830 on the fish-eye image 811.

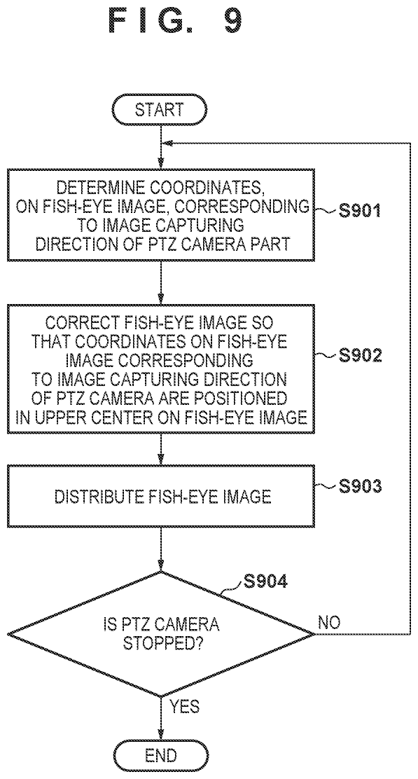

FIG. 9 is a flowchart illustrating fish-eye image output processing according to the second embodiment. In the present embodiment, the PTZ camera part 101 captures an image of the target 820 in FIGS. 8A and 8B, and the fish-eye camera part 108 captures an image with the target 820 being within the 3600 image capturing range. In the present embodiment, the coordinates, on the fish-eye image, corresponding to the image capturing direction of the PTZ camera part 101 are set to correspond to the specified coordinates on the fish-eye image captured by the fish-eye camera part 108. Specifically, in the present embodiment, the fish-eye image is rotated to position the image capturing direction of the PTZ camera part 101 at the upper center of the fish-eye image. The fish-eye image output processing according to the present embodiment will be described below with reference to FIG. 9.

In S901 in FIG. 9, the position processing unit 306 uses a table (not illustrated) that is stored in advance in the ROM 106 and indicates association between the image capturing direction of the PTZ camera part 101 and coordinates on the fish-eye image acquired by the fish-eye camera part 108. The position processing unit 306 determines which coordinates on the fish-eye image 801 in the table correspond to the image capturing direction of the PTZ camera part 101 received from the camera control unit 305. Next, the position processing unit 306 determines whether to correct the fish-eye image 801, based on whether the coordinates (hereinafter, referred to as detected coordinates) on the fish-eye image 801 corresponding to the image capturing direction of the PTZ camera part 101 correspond to the specified coordinates 810 corresponding to the upper center on the fish-eye image 801. Here, the detected coordinates are defined as image capturing position information. The present embodiment includes obtaining results of the two determinations by the position processing unit 306 described above. Note that the coordinates on the fish-eye image 801 corresponding to the image capturing direction of the PTZ camera part 101 and the specified coordinates 810 are expressed by a two-dimensional coordinate system (X, Y), for example.

When it is determined that the detected coordinates indicating the image capturing direction of the PTZ camera part 101 do not match the specified coordinates 810, the data forming unit 303 generates the fish-eye image 811 by correcting the fish-eye image 801 to position the detected coordinates at the specified coordinates 810 in S902. The data forming unit 303 may perform correction of rotating the fish-eye image based on a difference between the detected coordinates and the specified coordinates 810. When it is determined that the detected coordinates match the specified coordinates 810, the data forming unit 303 does not correct the fish-eye image 801. In S903, the communication processing unit 304 outputs the fish-eye image 811 generated by the data forming unit 303 in S902 or the fish-eye image 801. In S904, the position processing unit 306 determines whether the PTZ camera part 101 is changing the image capturing direction. When the position processing unit 306 determines that the PTZ camera part 101 is not changing the image capturing direction (Yes in S904), the processing ends. When the position processing unit 306 determines that the PTZ camera part 101 is changing the image capturing direction (No in S904), the processing returns to S901, and the position processing unit 306 obtains the image capturing direction of the PTZ camera part 101 after the image capturing direction is changed.

The present embodiment generates a fish-eye image corresponding to an image capturing direction of a PTZ camera in a multi-eye camera including the PTZ camera and a fish-eye camera, but this is not limited. The present embodiment may generate any of, for example, a panoramic image or a four-segmented image obtained by dewarping a fish-eye image and output such images and the like.

As described above, according to the second embodiment, a fish-eye image corresponding to an image capturing direction of a PTZ camera can be generated by using a multi-eye camera including the PTZ camera and a fish-eye camera. This enables the second embodiment to easily recognize where the captured image captured by the PTZ camera is displayed on the fish-eye image captured by the fish-eye camera.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-090589, filed May 28, 2021, which is hereby incorporated by reference herein in its entirety.

What is claimed is:

1. An information processing apparatus comprising:
an obtaining unit configured to obtain an image capturing direction information indicating an image capturing direction of a first image capturing part that can change the image capturing direction;
a determining unit configured to determine, in accordance with the image capturing direction of the first image capturing part, a second image capturing part having an image capturing direction closest to the image capturing direction of the first image capturing part in an image capturing part set including a plurality of image capturing parts having a different image capturing direction;
a generating unit configured to generate a combined image such that an image captured by the second image capturing part determined by the determining unit is arranged at a predetermined position in the combined image by combining images captured by the respective image capturing parts in the image capturing part set; and
an outputting unit configured to output the combined image generated by the generating unit.

2. The information processing apparatus according to claim 1 comprising
a storing unit configured to store a correspondence information in which the image capturing direction of the first image capturing part is associated with one image capturing part having an image capturing direction closest to an image capturing direction of the first image capturing part in the image capturing part set, wherein
the determining unit determines, in accordance with the correspondence information, the image capturing part having the image capturing direction closest to the image capturing direction of the first image capturing part in the image capturing part set.

3. The information processing apparatus according to claim 1, wherein
when the first image capturing part changes the image capturing direction, the obtaining unit obtains the image capturing direction information after the image capturing direction is changed.

4. The information processing apparatus according to claim 1, wherein
the image capturing part set includes a plurality of image capturing parts that can change an image capturing direction, and
the obtaining unit includes obtaining, when the plurality of image capturing parts in the image capturing part set individually changes the image capturing direction, image capturing direction information indicating an individual image capturing direction of the plurality of image capturing parts in the image capturing part set after the image capturing directions is changed.

5. The information processing apparatus according to claim 1, wherein
the first image capturing part can change the image capturing direction in at least one of a pan direction or a tilt direction.

6. The information processing apparatus according to claim 4, wherein
the plurality of image capturing parts in the image capturing part set can individually change the image capturing direction in at least one of a pan direction or a tilt direction.

7. The information processing apparatus according to claim 1, wherein
the outputting unit further outputs an image captured by the first image capturing part.

8. The information processing apparatus according to claim 1 comprising
a receiving unit configured to receive a user selection for determining the predetermined position.

9. The information processing apparatus according to claim 1, wherein
the predetermined position is a center of the combined image.

10. An information processing apparatus comprising:
an obtaining unit configured to obtain an image capturing position information indicating an image capturing position of a first image capturing part that can change the image capturing position;
a determining unit configured to determine, in accordance with the image capturing position information of the first image capturing part, coordinates corresponding to the image capturing position of the first image capturing part on an omnidirectional image captured by an omnidirectional image capturing part that can perform omnidirectional image capturing;
a generating unit configured to correct the omnidirectional image to generate an omnidirectional image such that the coordinates is positioned at specified coordinates prespecified on the omnidirectional image; and
an outputting unit configured to output the omnidirectional image generated by the generating unit.

11. An information processing apparatus comprising:
an obtaining unit configured to obtain an image capturing position information indicating an image capturing position of a first image capturing part that can change the image capturing position;
a generating unit configured to generate an omnidirectional image in accordance with an image capturing result from an omnidirectional image capturing part that can perform omnidirectional image capturing such that coordinates corresponding to the image capturing position of the first image capturing part on the omnidirectional image are positioned at specified coordinates prespecified on the omnidirectional image; and
an outputting unit configured to output the omnidirectional image generated by the generating unit.

12. The information processing apparatus according to claim 10 comprising
a storing unit configured to store a correspondence information in which the image capturing position of the first image capturing part is associated with one set of coordinates corresponding to the image capturing position of the first image capturing part of coordinates of the omnidirectional image, wherein
the determining unit determines, in accordance with the correspondence information, coordinates corresponding to the image capturing position of the first image capturing part on the omnidirectional image.

13. The information processing apparatus according to claim 10, wherein
when the first image capturing part changes the image capturing position, the obtaining unit obtains the image capturing position information after the image capturing position is changed.

14. The information processing apparatus according to claim 10, wherein
the outputting unit further outputs an image captured by the first image capturing part.

15. The information processing apparatus according to claim 10, wherein
the first image capturing part can change the image capturing position in at least one of a pan direction or a tilt direction.

16. The information processing apparatus according to claim 10, wherein
the omnidirectional image is a fish-eye image,
the generating unit generates at least one of a panoramic image or a segment image obtained by dewarping the fish-eye image, and
the outputting unit outputs at least one of the panoramic image or the segment image generated by the generating unit.

17. The information processing apparatus according to claim 10, wherein
when the omnidirectional image is a fish-eye image, the generating unit rotates the omnidirectional image to generate an omnidirectional image such that the coordinates corresponding to the image capturing position of the first image capturing part on the omnidirectional image are positioned at the specified coordinates prespecified on the omnidirectional image.

18. The information processing apparatus according to claim 10 comprising
a receiving unit configured to receive a user selection for determining the specified coordinates.

19. The information processing apparatus according to claim 18, wherein
the specified coordinates are located on an upper center on the omnidirectional image.

20. An image capturing apparatus comprising:
an image capturing part that can change an image capturing direction; and
the information processing apparatus according to claim 1.

21. An information processing method comprising:
obtaining an image capturing direction information indicating an image capturing direction of a first image capturing part that can change the image capturing direction;
determining, in accordance with the image capturing direction of the first image capturing part, a second image capturing part having an image capturing direction closest to the image capturing direction of the first image capturing part in an image capturing part set including a plurality of image capturing parts having a different image capturing direction;
generating a combined image such that an image captured by the second image capturing part determined by the determining is arranged at a predetermined position in the combined image by combining images captured by the respective image capturing parts in the image capturing part set; and
outputting the combined image generated by the generating.

22. A non-transitory computer readable storage medium storing a program that, when executed by a computer, causes the computer to perform an information processing method comprising:
obtaining an image capturing direction information indicating an image capturing direction of a first image capturing part that can change the image capturing direction;
determining, in accordance with the image capturing direction of the first image capturing part, a second image capturing part having an image capturing direction closest to the image capturing direction of the first image capturing part in an image capturing part set including a plurality of image capturing parts having a different image capturing direction;
generating a combined image such that an image captured by the second image capturing part determined by the determining is arranged at a predetermined position in the combined image by combining images captured by the respective image capturing parts in the image capturing part set; and
outputting the combined image generated by the generating.
